(19) United States
(12) Patent Application Publication
(10) Pub. No.: US 2012/0241183 A1
(43) Pub. Date: Sep. 27, 2012

(54) POWER TOOL

(75) Inventor: Cheng D. Li, Suzhou (CN)

(73) Assignee: Positec Power Tools (Suzhou) Co., Ltd., Suzhou (CN)

(21) Appl. No.: 13/395,328

(22) PCT Filed: Sep. 8, 2010
(86) PCT No.: PCT/CN10/76711

§ 371 Date: Apr. 26, 2012

(30) Foreign Application Priority Data
Sep. 10, 2009 (CN) 200910176229

(51) Int. Cl. B25B 21/02

(52) U.S. Cl. 173/48

(57) ABSTRACT

The present invention relates to a power tool, including a housing, a motor, and a speed adjusting system decelerating the rotate rotation speed of said motor. The speed adjusting system comprises a includes an output, a main shaft connecting to the output, and a working shaft employed for adapting with corresponding working head during working. The main shaft is connected with a hammer that can move axially against the main shaft. The working shaft is connected with an anvil that rotates together with the working shaft. The hammer has first teeth, the anvil has second teeth, and the hammer drives the anvil on rotate direction through the cooperation between the first teeth of the hammer and the second teeth of anvil. The power tool also includes a clutch, which can move between the first position and the second position to optionally rigidly connect the hammer with at least one of the output and the main shaft.

### CROSS-REFERENCE TO RELATED APPLICATION

The present application is the entry into the U.S. National Phase of PCT/CN2010/076711, filed Sep. 8, 2010, which claims priority to Chinese Patent Application No. CN200910176229.X, filed Sep. 10, 2009, each of which is incorporated herein in its entirety.

### TECHNICAL FIELD

The present disclosure relates to a power tool, especially to a kind of multifunctional power tool that can achieve the functions of the impact wrench, and the functions of the electric drill, the electric screwdriver or the percussion drill.

### BACKGROUND

Among the existing power tools, the impact wrench is used to fasten the threaded fastener to workpieces. The impact wrench usually comprises a main shaft driven and rotated by motor, an hammer connected with the main shaft through the cooperation of a helical groove and a rolling ball, and a working shaft situated at the front of the hammer and cooperating with the hammer through end teeth. At the back of the hammer, there is an impact-spring which oppresses the hammer to maintain the reliable cooperation between the hammer and the working shaft. During working, the rotation motion of the main shaft is directly transferred to threaded parts through the hammer and the working shaft's anvil in order to fasten threaded parts to workpiece. During such fastening, the load of the working shaft becomes heavier and heavier. When the load exceeds the pre-set value, the hammer will move against the axial direction of the anvil mounted on the working shaft and towards the motor, and at the same time, the spring at the back of the hammer will be compressed due to such movement. At the moment when the hammer does not engage with the end teeth of the anvil mounted on the working shaft, the action of the impact-ring causes the hammer to move ahead axially and to impact the anvil mounted on the working shaft in the rotation direction in order to make the working shaft fasten the threaded parts in the rotation direction. Repeatedly like this, the intermittently impacting of the hammer ensures that threaded parts are fastened to workpieces finally. The electric drill is used to drill workpieces. However, users usually need to fasten threaded parts to workpieces or to drill workpieces when they work. In this case, it will be very troublesome for users to change tools during work.

In order to overcome the above troubles, people have developed a kind of power tool with the functions of both the impact wrench and the electric drill. The two functions of such power tool are usually switched by a function switch. Actually, the function switch can be achieved in many ways. One relatively common and simple way is to use a mobile stopper to optionally limit the axially backward movement of the hammer. Like this, when the stopper does not limit the axially backward movement of the hammer, the hammer can achieve the function of the impact wrench as described above. When the stopper limits the axially backward movement of the hammer, the hammer will maintain its joining with the working shaft, and will not compress the spring at its back in order to achieve functions of energy-accumulation impact and the electric drill. For example, in the China patent application (CN200510099106), a power tool is disclosed. At the back of the hammer of this power tool, an axially mobile stopper is mounted. When contacting the back of the hammer, this stopper limits the axially backward movement of the hammer for the purpose of achieving the function of the electric drill. When this stopper moves axially upward and does not contact the back of the hammer, the power tool gives the function of the impact wrench into play. However, when such function switching mechanism switches to the function of the electric drill, rotation is transferred by the rolling ball structure in the slide groove between the main shaft and hammer; and the rolling ball, main shaft and hammer are connected in mobile way. As a result, the stopper limiting the axially backward movement of the hammer will bear relatively big force from the hammer; and the hammer moves against the stopper, which wears the stopper heavily. In conclusion, such rotation transferring is not stable.

### SUMMARY

The disclosure provides a kind of power tool, which comprises of a function switch mechanism to switch among the functions of the impact wrench and the function of the electric drill, or the screwdriver or the percussion drill. The rotation transferring of the electric drill function of this power tool is stable.

the disclosure provides:

A power tool, comprising: a housing (1); a motor (11) set in said housing, said motor output rotating movement; a speed adjusting system (13) decelerating the rotate speed of said motor, said speed adjusting system comprises a output (22), a main shaft (24) connecting to said output, and a working shaft (5) employed for adapting with corresponding working head during working, said main shaft is connected with an hammer (31), said hammer (31) can move axially against said main shaft, said working shaft is connected with an anvil (51), said anvil rotates together with said working shaft, said hammer having first teeth (311) and said anvil having second teeth (511), said hammer drives the anvil on rotate direction through the cooperation between said first teeth of the hammer and said second teeth of anvil; wherein said power tool also comprises: a clutch (41), which can move between the first position and the second position so as to optionally rigidly connect said hammer with at least one of said output and said main shaft.

Preferably, said clutch can operably move axially between said first position and second position so as to rigidly connect said hammer with at least one of said output and said main shaft, so that the hammer rotate together with at least one of said output and said main shaft.

Preferably, a spline (417) or end teeth are provided at the part of the clutch facing the hammer, and a matching spline (317) or end teeth are provided at the part of the hammer facing said clutch, when the clutch is at said second position, the splines or end teeth of the clutch and the hammer engage with each other so as to form a rigid connection.

Preferably, said clutch is of ring shape so as to connect with said output in muff-coupling way, The inner circumferential surface of said clutch having a slide block (413) protruding radially; said output is provided with a slide groove (221), said slide groove is concave extending axially so as to accept said slide block moving within it.

Preferably, the inner circumferential surface of said clutch having an inner annular groove (415) in which elastic ring (45) is set, the outer circumferential surface of said output having a first annular groove (223) and a second annular groove (225), said clutch drives the elastic ring to move to make the elastic ring optionally sitting in said first annular groove or said second annular groove, and accordingly the clutch sit at said first position or said second position.

Preferably, the power tool comprises a function switch (44) mounted on said housing (1), said function switch connects the clutch through a connector (42) mounted in said housing and drives the clutch to move between said first position and said second position.

Preferably, the power tool comprises an impact-spring (32) that elastically against the end of said hammer which far from said anvil, and a ball (25) situated between said hammer and said main shaft, an inner V-shaped groove (312) and an outer V-shaped groove (241) in which the ball rolls are respectively provided to the wall of said hammer and the wall of said main shaft.

Preferably, the power tool comprises an impact mechanism, which realizes the function of the impact wrench by impacting the anvil intermittently with the hammer.

Preferably, the power tool can achieve drilling function, electric screwdriver function or percussion drilling function.

Preferably, the function switch comprises an operating part outside the housing and an annular part in the housing, a track channel is provided for said annular part, and the one end of the connector is in said track channel, said operating part is operable and drives the track channel of the annular part to move, so that the connector is driven to move axially.

Comparing with the current technology, possible benefits of the present disclosure may in some arrangements include: a clutch that can move optionally between the two positions is provided additionally for the power tool, in order to optionally rigidly connect at least one of the output and main shaft with the hammer, so that rotation transferring can be stably and effectively achieved when the power tool is in the drilling mode, percussion drilling mode or screwdriver mode, and so can impacting when in impacting mode. The above-said function switch mechanism is simple and stable in structure, low in manufacturing cost, convenient and easy in operation.

### BRIEF DESCRIPTION OF THE DRAWINGS

The present disclosure is further detailed in combination with the drawings attached and embodiments hereinafter, wherein:

FIG. 1 is the front view of the power tool of the disclosure.

FIG. 2 is the internal view of the power tool of the disclosure.

FIG. 3 is the structural view when the power tool of the disclosure is in the mode of the impact wrench function.

FIG. 4 is the structural view when the power tool of the disclosure is in the mode of the drilling function.

### DETAILED DESCRIPTION

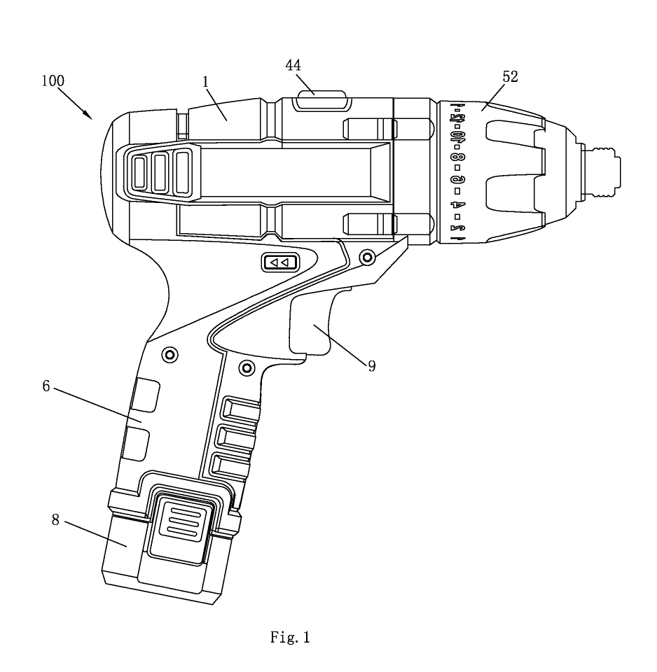

FIGS. 1-4 show a power tool 100 as an embodiment of the disclosure. In this embodiment, the power tool 100 provide the functions of drilling and impact wrench. As shown in the FIG. 1, the power tool 100 comprises a horizontally situated housing 1, a handle 6 forming an angle with the housing 1, and a detachable battery pack 8 situated at the bottom of the handle 6. At the front of the housing 1, a tool chuck 52 is mounted to hold various working heads when the power tool achieves different functions (not shown in figures). For example, the tool chuck 52 is used to hold fastener head when the power tool achieves the function of the impact wrench, and to hold the spiral drill when the power tool achieves the function of the drilling. Trigger 9 is mounted on the handle 6. Operator can press the trigger 9 to start the power tool 100. Function switch 44 is mounted on the housing 1. Operator can switch the function modes of the power tool 100 by move the function switch 44.

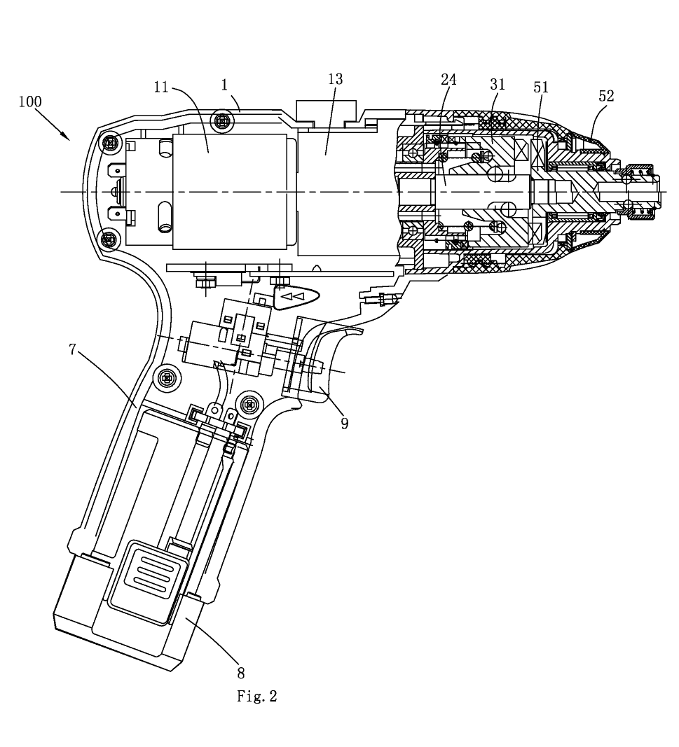

FIG. 2 shows the power tool 100's working parts mounted in the housing 1. As shown in FIG. 2, the working parts comprises motor 11 and motor shaft extending ahead of the motor 11 (not shown in the figures). According to this embodiment, the speed adjusting system 13 is a planetary gear speed adjusting system, of which the actual realization way is known to common technicians in the industry. So, this actual realization way is not described in detail here. When the motor 11 runs, the motor shaft drives the planetary gear speed adjusting system to run. Accordingly, the rotation output by the motor is transferred to the main shaft 24 connected with the output 22 of the planet gear speed adjusting system in some deceleration proportion. The output 22 is the endmost planet carrier of the planetary gear speed adjusting system. The main shaft 24 inserts this planet carrier in interference fit way to joint with the output 22 deadly. When the output 22 rotates, the main shaft 24 will follow such rotate.

A mechanism used for achieving the function of the impact wrench is mounted at the front of the speed adjusting system 13. The mechanism comprises a hammer 31 mounted on the main shaft 24, a impact-spring 32 mounted between the hammer 31 and the output 22, and the rolling ball V-shaped groove impact mechanism mounted between the hammer 31 and the main shaft 24. This impact mechanism comprises an outer V-shaped groove 241 hollowly formed on the surface of the main shaft 24, the rolling ball 25 (a steel ball in this embodiment) that can roll in the outer V-shaped groove 241, and the inner V-shaped groove 312 formed on the hammer 31 for receiving the ball 25. A pair of first teeth 311 are provided on the front surface of the hammer 31 in axial symmetry and protruding way. Gasket and washer are provided between the impact-spring 32 and the hammer 31. At the front of the hammer 31, anvil 51 is mounted. A pair of second teeth 511 are provided on the back surface of the anvil 51 (opposite to the hammer 31) in axial symmetry and protruding way. The working parts also comprise a working shaft 5 extending to the front of the housing 1, and the chuck 52 mounted at the front of the working shaft in muff-coupling way. The anvil 51 and the working shaft 5 combines together as a whole. At the front of the working shaft 51, receiving groove 512 is provided for receiving corresponding working heads when various functions are achieved and for holding and fastening by the tool chuck 52.

The function-adjusting mechanism provided between hammer 31, main shaft 24 and speed adjusting system 13 is also a working part. It comprises clutch 41, function switch 44 and connector 42. Wherein, the clutch 41 is in a ring-like form, and is provided around the outer circumferential surface of output 22. A round of outer annular groove 411 is provided on the outer circumferential surface of clutch 41, one end of connector 42 is hooked to the inside of outer annular groove 411, and the other end of the connector is provided on the housing 1 through connection by the function switch 44 for the operator to operate, move the function switch 44 so as to drive the connector 42 and clutch 41 successively to move back and forth along the axis of output 22. For those of ordinary skill in the art, this is also practicable: directly connect a hinge pin with the function switch 44, and pass through the housing 1 through the hinge pin to connect to the clutch 41, which can then be driven to move back and forth. As for specifics of such connection, the function switch 44 is arranged to the housing 1 in a penetrating manner, including an operating part located on the housing 1 and a circular part located in the housing. The operating part can rotate around the longitudinal axis of working shaft 5 and drive the circular part to rotate. Some track channels are provided on the circular part, and include two straight channels parallel to the direction which is perpendicular to the longitudinal axis of working shaft 5, and provided at intervals along the longitudinal axis of working shaft 5, as well as a skewed channel connecting the above-said two straight channels. The other end of the said connector 42 is provided in a track channel. To be specific, it is in one of the two straight channels. In function conversion, after the operator stirs the operating part of function switch, the circular part will rotate according to the motion, and the track channels will also move according to the circular part 7 in a direction opposite to the other end of connector 42. During the moving process of track channels, firstly, a straight channel connects with the other end of connector 42 and moves relative to the connector 42, while connector 42 does not move axially; then, the skewed channel of track channels moves to the other end of connector 42, and continues moving to drive the connector 42 to move axially till skewed channel moves to leave the said end, and the other straight channel moves to the position where the other end of connector 42 can be connected. Function switch 44 drives the connector 42 to move axially in the above-mentioned way. Yet for those of ordinary skill in the art, there are various ways to connect and control function switch and clutch 41, apart from the above-said means. For instance, the function switch 44 can be radially traversed to the inside of outer annular groove 411 on the outer circumferential surface of clutch 411, to directly drive the clutch 411 to move axially. The symmetrical part of the inner circumferential surface of clutch 41 radially bulges to form a pair of slide blocks 413, which are disconnected in the middle, and depressed toward the clutch 41 to form an inner annular groove 415, in which elastic ring 45 is provided. Correspondingly, the symmetrical part on the outer circumferential surface of output 22 is depressed radially to form a pair of slide grooves 221, and two ring-like grooves are provided on the outer circumferential surface of output 22 and within the axial layout travel of slide groove 221, which is vertical to and intersects with the ring-like grooves. They are respectively the first annular groove 223 relatively closer to one side of reducing gear system, and the second annular groove 225 relatively closer to one side of hammer 31. The clutch 41 moves back and forth through slide blocks along the inner axis of slide groove 221 of output 22, but cannot rotate around the output 22. The main body of elastic ring 45 is provided in the inner annular groove 415 of clutch 41, and moves axially on the outer circumferential surface of output 22 according to the clutch 41. Moreover, when reaching the two ring-like grooves of output 22, the elastic ring 45 will enter into them and locate along the two axial directions of output 22, and when it locates at the first annular groove 223, the clutch 41 lies in the first position, and when it at the second annular groove 225, the clutch 41 the second position. This arrangement can help the operator to determine whether the clutch has reached the predetermined position or not, and fix the clutch 41 at the position to avoid any random slide except the operator manually moves it.

A spline 417 is axially provided on the clutch 41 in front of hammer 31. Meanwhile, a corresponding spline 317 is provided on the axial back end of hammer 31 which facing the clutch 41 so that the clutch 41 and spline 417 can be geared. When the elastic ring 45 is positioned at the first annular groove 223, there is a certain space between the clutch 41 and hammer 31, the spline parts of which are out of gear; when the elastic ring is positioned at the second annular groove 225, the clutch 41 and hammer 31 fit together, with their respective spline parts geared.

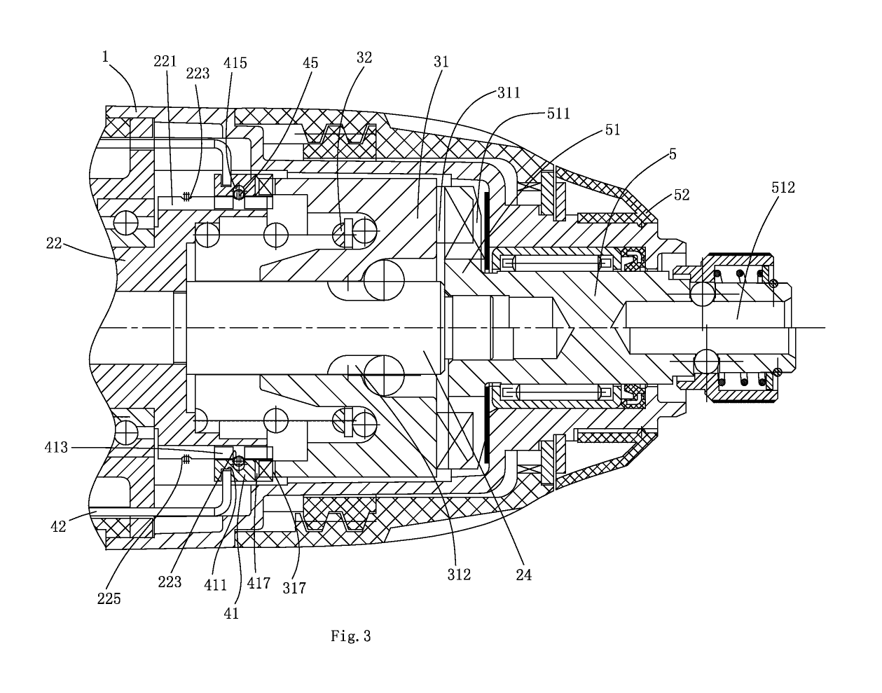

FIG. 3 shows the work by the power tool 100 to realize the function of impact wrench. In the process of realizing the function, when function switch 44 is adjusted to the position where the elastic ring 45 of clutch 41 is positioned at the first annular groove 223 of output 22, the spline 417 of clutch 41 and spline 317 of hammer 31 are out of gear. Since the first teeth 331 of hammer 31 is geared with the second teeth 411 of anvil 41 due to the pressure by impact-spring 32, the anvil 41 is restricted so that it can not move. When power tools work, main shaft 24 is rotated and driven by the motor shaft through speed adjusting system 13, the hammer 31 is driven and rotates by the ball 25 clamped between inner V-shaped groove 312 and outer V-shaped groove 241, As the anvil 41 also rotates follow that motion, it rapidly fasten nuts (not shown in figures) through working shaft 51, the working head (not shown in figures) and tool chuck 52.

After the nut end surface contacts with the workpiece (not shown in figures) surface, resisting moment rapidly increases to a certain value to make the geared hammer 31 and anvil 41 blocked, and the anvil 41 stopped rotating. Yet, the main shaft 24 still rotates under the driving force of motor output shaft, which forces the ball 25 to roll along the grooves by overcoming the frictional force between itself and inner V-shaped groove 312 outer V-shaped groove 241, to propel the hammer 31 to move to the direction of motor, making impact-spring 32 compressed. Thus, the hammer 31 is gradually axially move farther and farther from the anvil 41. When the axial moving distance of hammer 31 exceeds the tooth height of the second teeth 411 of anvil 41, that is to say, at the moment the hammer 31 and anvil 41 are out of gear, the main shaft 24 drives the hammer 31 to rotate, and make its first teeth 31 to glide over the second teeth 411 of anvil 41. And at the moment of the gliding and on account of the effect by impact-spring 32, the ball 25 returns to the original position again along the inner V-shaped groove 312 outer V-shaped groove 241, the hammer 31 is pushed forward, and as the rotation of main shaft 24 accelerates to impact the second teeth 411 of anvil 41, the anvil 41 continues moving along the rotating direction. As a result of the cycle, thread pieces are fastened under impact moment.

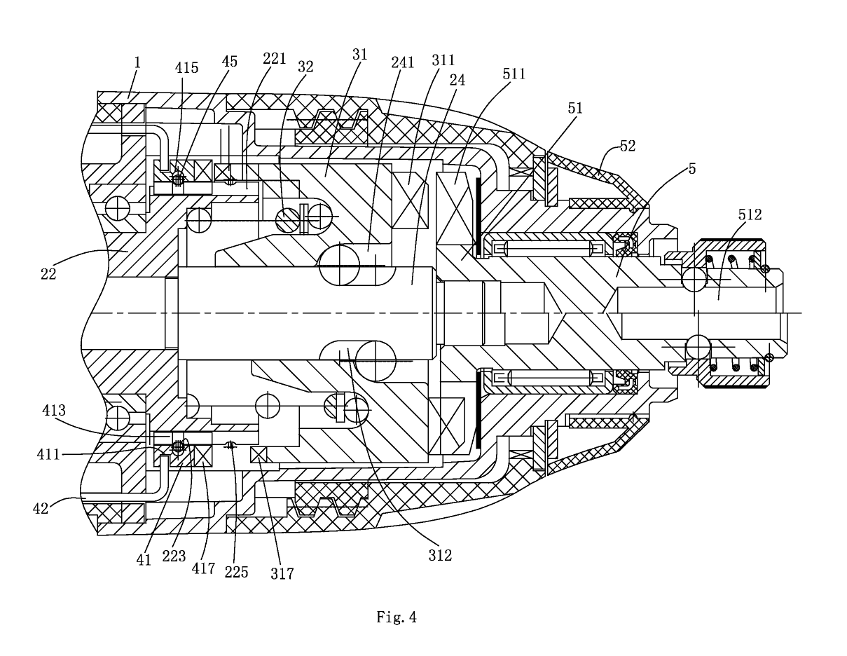

In the process of realizing the above impact wrench function, the hammer 31 is required to impact the anvil 51 by intermittent rotation, making the working head (fastening head) to fasten nuts. However, in the process of realizing the drilling function, only the working head (spiral drill) is required to continue drilling, and the hammer 31 isn't required any more for intermittent impact. As shown in FIG. 4, when function switch 44 is adjusted to the position where the elastic ring of clutch 41 is positioned at the second annular groove 225 of output 22, or the gearing position of the spline 417 of clutch 41 and spline 317 of hammer 31, the power tool 100 is in the working state of drilling function realization. In drilling process, the hammer 31 tends to move toward motor 11 due to the gradually increasing resisting force suffered by working shaft 5. At this time, since the clutch 41 restricts the hammer 31 to move backward axially, the first teeth 311 of hammer 31 always fits the second teeth 511 of anvil 51. Meanwhile, the hammer 31, anvil 41 and working shaft 51 move together along the rotating direction. Since the anvil 41 and hammer 31 can never be separated, or impact can never be formed between them, continuous drilling of the working head can be ensured.

For the above-said implementing modes, it is especially important that in drilling function realization, the rotation outputted by the motor can reach the output 22 of speed adjusting system through deceleration, and then pass to the hammer 31 through the middleware clutch 41. As a result, a rigid connection from the output 22 of speed adjusting system to hammer 31 for passing rotation is formed; since the main shaft 24 and output 22 of speed adjusting system are connected through interference fit, it can be said that a rigid connection between the main shaft 24 and hammer 41 is established. As for the past power tool 100, when its impact wrench function is converted to the drilling function, the movable connection of the grooves and rolling ball system between the main shaft 24 and hammer 41 have to be relied on to pass rotation.

For those of ordinary skill in the art, the clutch 31 can be optionally directly provided on the outer circumferential surface of main shaft 24, where it can glide along the axial direction of main shaft 24. In this embodiment, some of clutch 41 is connected with the main shaft 24 along the rotating direction in a relatively fixed mode, and some of the clutch 41 is optionally geared or separated from the hammer 31 under the help by the spline. As a result, a rigid connection from the main shaft 24 to hammer 41 is established under the drilling mode of power tool 100. This embodiment is in the same clues as the above-said preferred implementing cases of this disclosure, and thus it is unnecessary to dwell on its details herein. The rotation output of the motor 11 is decelerated by the speed adjusting system and then passed to the hammer 31 by means of the rigid connected transmission.

Also for those of ordinary skill in the art, the clutch 41 can be optionally rigid connected with the hammer 31 in a form other than spline gearing, or be relatively fixedly geared with the output 22 or main shaft 24 along the rotating direction in a way different from the slideway form of slide block. For example, clips and holes can be adopted for gearing, or lugs and grooves for gearing to realize optional and rigid connection between the clutch 41 and hammer 31, the spline gearing can be adopted to realize the gearing between the clutch 41 and output 22 or main shaft 24, etc.

In other embodiments, when the anvil moves with the hammer, the function of automatic screwdriver can be correspondingly realized by adding a clutch mechanism between the planetary gear speed adjusting system of power tool and inner ball V-shaped groove impact structure, and the function of percussion drill can be correspondingly realized by adding a dynamic and static end tooth hammer structure (percussion mechanism) in front of the working shaft 5. The above functions can be separately provided and integrated into a power tool by being combined with the function of impact wrench, and be provided repeatedly to form power tools with three or four functions. Since the above added functional structures are prior art, it isn't necessary to dwell on them herein.

1. A power tool, comprising:
a housing;
a motor set in said housing, said motor output rotating movement;
a speed adjusting system for decelerating the rotation speed of said motor, said speed adjusting system comprises an output, a main shaft connecting to said output, and a working shaft employed for adapting with a corresponding working head during working, said main shaft is connected with an hammer, said hammer can move axially against said main shaft, said working shaft is connected with an anvil, said anvil rotates together with said working shaft, said hammer having first teeth and said anvil having second teeth, said hammer drives the anvil in a rotation direction through the cooperation between said first teeth of the hammer and said second teeth of anvil; and
a clutch, which can move between the first position and the second position so as to selectively rigidly connect said hammer with at least one of said output and said main shaft.

2. A power tool according to claim 1, wherein said clutch can operably move axially between said first position and second position so as to rigidly connect said hammer with at least one of said output and said main shaft, so that the hammer rotates together with at least one of said output and said main shaft.

3. A power tool according to claim 1, wherein a first spline or end teeth are provided at a part of the clutch facing the hammer, and a matching second spline or end teeth are provided at a part of the hammer facing said clutch, and wherein, when the clutch is at said second position, the first and second splines or end teeth of the clutch and the hammer engage with each other so as to form a rigid connection.

4. A power tool according to claim 1, wherein said clutch is of ring shape so as to connect with said output in a muff-coupling way, an inner circumferential surface of said clutch having a slide block protruding radially; said output is provided with a slide groove, said slide groove is concave extending axially so as to accept said slide block moving within it.

5. A power tool according to claim 1, wherein an inner circumferential surface of said clutch has an inner annular groove in which an elastic ring is set, an outer circumferential surface of said output has a first annular groove and a second annular groove, said clutch drives the elastic ring to move to make the elastic ring selectively sit in said first annular groove or said second annular groove, and accordingly the clutch sit at said first position or said second position.

6. A power tool according to claim 1, wherein the power tool comprises a function switch mounted on said housing, said function switch connects the clutch through a connector mounted in said housing and drives the clutch to move between said first position and said second position.

7. A power tool according to claim 1, wherein the power tool comprises an impact-spring that elastically engages against an end of said hammer which facing away from said anvil, and a ball situated between said hammer and said main shaft, an inner V-shaped groove and an outer V-shaped groove in which ball rolls are respectively provided to a wall of said hammer and a wall of said main shaft.

8. A power tool according to claim 1, wherein the power tool comprises an impact mechanism, which impacts the anvil intermittently with the hammer.

9. A power tool according to claim 1, wherein the power tool can achieve a drilling function, an electric screwdriver function, and a percussion drilling function.

10. A power tool according to claim 6, wherein the function switch comprises an operating part outside the housing and an annular part in the housing, a track channel is provided for said annular part, and one end of the connector is in said track channel, said operating part is operable and drives the track channel of the annular part to move, so that the connector is driven to move axially.
